(19) United States
(12) Patent Application Publication
(10) Pub. No.: US 2017/0249012 A1
(43) Pub. Date: Aug. 31, 2017

(54) METHOD OF PROVIDING AUDIBLE FEEDBACK ON A TOUCH SENSOR USING HAPTICS

(71) Applicant: CIRQUE CORPORATION, Salt Lake City, UT (US)

(72) Inventor: David C. Taylor, West Jordan, UT (US)

(21) Appl. No.: 15/442,942

(22) Filed: Feb. 27, 2017

Related U.S. Application Data
(60) Provisional application No. 62/299,706, filed on Feb. 25, 2016.

(51) Int. Cl. G06F 3/01; G06F 3/041; G06F 3/044

(52) U.S. Cl. CPC G06F 3/016; G06F 3/044; G06F 3/0416

(57) ABSTRACT

A system and method for using haptic technology to generate audible feedback or audible and tactile feedback when using a touch sensor to provide information about the nature of contact with the touch sensor, wherein the system and method may be independent of operating system and driver, but instead be integrated into the touch sensor system.

### BACKGROUND OF THE INVENTION

Field of the Invention

This invention relates generally to touch sensors and haptics. More specifically, the invention pertains to providing audible feedback through the use of haptic technology.

Description of the Prior Art

There are several designs for capacitance sensitive touch sensors which may take advantage of a system and method of the invention. It is useful to examine the underlying technology of the touch sensors to better understand how any capacitance sensitive touchpad can take advantage of the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can function as the X or Y electrodes 12, 14 by using multiplexing.

It should be understood that use of the term “touch sensor” throughout this document may be used interchangeably with “forcepad”, “touchpad”, “proximity sensor”, “touch and proximity sensor”, “touch panel” and “touch screen”.

### BRIEF SUMMARY OF THE INVENTION

In a first embodiment, the present invention is a system and method for using haptic technology to generate audible feedback or audible and tactile feedback when using a touch sensor to provide information about the nature of contact with the touch sensor, wherein the system and method may be independent of operating system and driver, but instead be integrated into the touch sensor system.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a touchpad that is found in the prior art, and which is adaptable for use in the present invention.

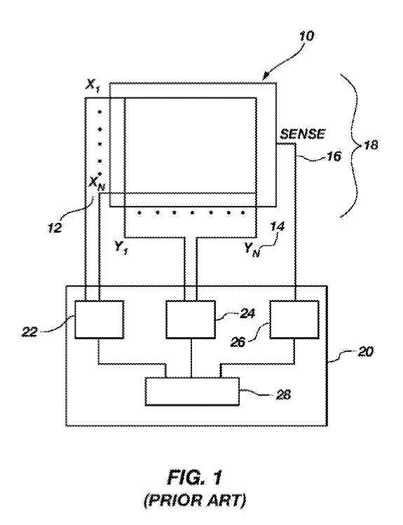

FIG. 2 is a block diagram of a first embodiment of the invention wherein a single haptic device provides audible feedback in response to touch or proximity to a touch sensor.

FIG. 3 is a block diagram of a different embodiment of the invention wherein two haptic devices provide separate audible feedback and tactile feedback in response to touch or proximity to a touch sensor.

FIG. 4 is a top view of a touch sensor and a haptic device disposed underneath but in contact with the touch sensor.

FIG. 5 is a profile view of a housing for a touch sensor with the haptic device disposed directly on the housing.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Haptic technology recreates a sense of touch by applying forces, vibrations or motions to a user in contact with a haptic device, or in contact with a device that is connected to the haptic device. Another type of feedback that may be associated with a touch sensor is audible. Audible feedback is provided by a speaker to generate sound for the user.

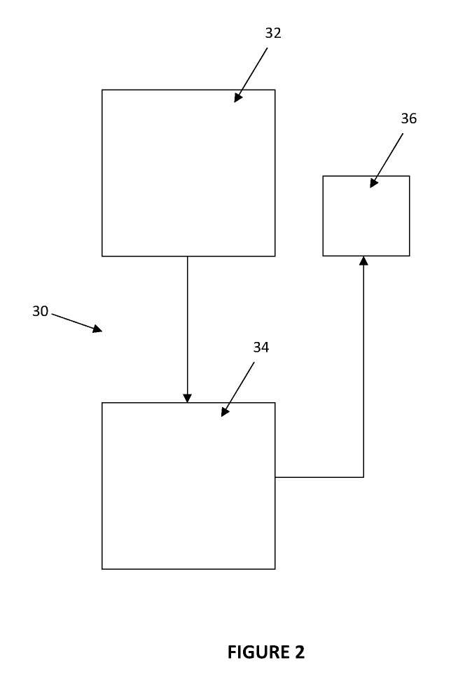

In a first embodiment of the present invention, audible feedback may be generated by a haptic device instead of a speaker using an audible feedback system as known to those skilled in the art. FIG. 2 is a block diagram of the first embodiment of the invention. In this figure, a touch sensor system 30 includes a touch sensor 32 that may transmit touch data or touch data signals to a touch controller 34. The touch controller 34 may process the touch data to determine the type of contact that is being made with the touch sensor 32.

It should be understood that the haptic device may have an audible feedback system, a haptic feedback system, or both, and that these systems may be the same system that enables the haptic device to provide the desired haptics or audible sound.

It should be understood that the term “touch” may also include proximity detection of one or more objects within sensor range of a touch and proximity sensor. Contact may also be made with the touch sensor by one or more pointing objects that are detectable by the touch sensor.

The touch controller 34 may transmit control signals directly to a haptic device 36 using information from the touch data signals being sent from the touch sensor 32 to the touch controller 34. The touch controller 34 may include a memory that enables the touch controller to transmit control signals to generate a variety of different sounds by the haptic device 36. In addition, the audible feedback may be generated by the haptic device 36 independently of any driver or operating system because the haptic device may only receive control signals from the touch controller 34. Thus, the audible feedback from the touch sensor system 30 may be an integrated feature of the touch sensor system 30 itself, and not a feature of a driver or operating system.

The methods of generating the variety of different sounds by the haptic device may include, but should not be considered as limited to, changing a frequency, changing a volume, changing the length and changing the number of audible sounds.

In an alternative embodiment of the invention, the haptic device 36 may generate both audible feedback and haptic feedback. The haptic device 36 may generate audible feedback and haptic feedback simultaneously or at different times. The touch controller 34 may be capable of sending the control signals for both audible and haptic feedback to the haptic device 36.

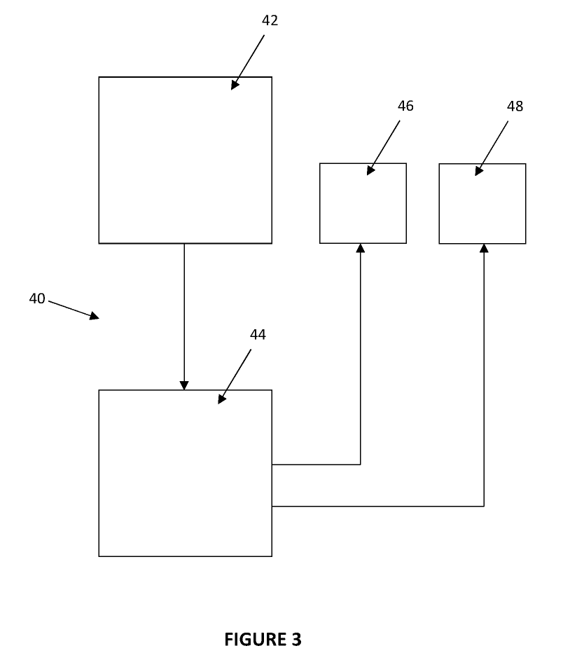

FIG. 3 is a block diagram of another embodiment of the present invention. In this embodiment, the touch sensor system 40 includes a touch sensor 42, a touch controller 44, a first haptic device 46 and a second haptic device 48. The first haptic 46 and the second haptic device 48 may be dedicated to a particular feedback function such as audible feedback, to haptic feedback, or to both. The haptic devices 46, 38 may both generate the same type of feedback or different types of feedback. The haptic devices 46, 48 may also change the type of feedback that they generate.

One reason for using a haptic device to generate audible feedback is that the haptic device may already be present to provide haptic feedback for use with a touch sensor. If the same haptic device can be used for both audible and haptic feedback, the cost, the size and/or energy usage of the touch sensor system 30, 40 may be reduced by eliminating a speaker.

Audible feedback of the status of a touch sensor may provide very useful information to a user. For example, audible feedback may be used to indicate the nature of the contact that the touch sensor is detecting. Different types of touch may include different gestures that may be detected by the touch sensor. Gestures may be simple gestures that involve simple movements of a pointing object to create a tap, double tap, tap and drag, tap and touch, etc. More complex gestures may include swiping, scrolling, motions that change direction, detection of multiple objects, etc. It should be understood that the invention is not limited to the examples above, and that any gesture should be included within the different types of touch or proximity gestures that can be detected by the touch sensor 32, 42.

Some other useful information that may be given to a user through audible feedback from a haptic device is an indication of where contact is being made on a touch sensor by one or more pointing objects. For example, a continuous sound may be generated by the haptic device. The sound may have a low frequency when a pointing object is near a boundary of the touch sensor and may increase in frequency until a center of the touch sensor is reached.

Another example of information that may be given to the user from audible feedback may pertain to force. For example, a continuous sound may be generated when contact is made with the touch sensor. The sound may have a low frequency when the amount of force that is being applied is small, and the sound may increase in frequency as more force is applied to the touch sensor. Volume or other characteristics of sound may also be used exclusively or in combination to provide information to the user.

The haptic feedback from the haptic device 36 may be a single tone indicating the start or end of a gesture, such as a tap, or haptic feedback may be a continuous tone during the duration of a gesture, such as during an inertial scroll. During an inertial scroll, for example, the continuous tone may also change frequency over the duration of the tone. For example, the frequency of the continuous tone may indicate the speed of the scrolling by being a high frequency at the beginning of the scrolling and decreasing in frequency as the scrolling speed decreases.

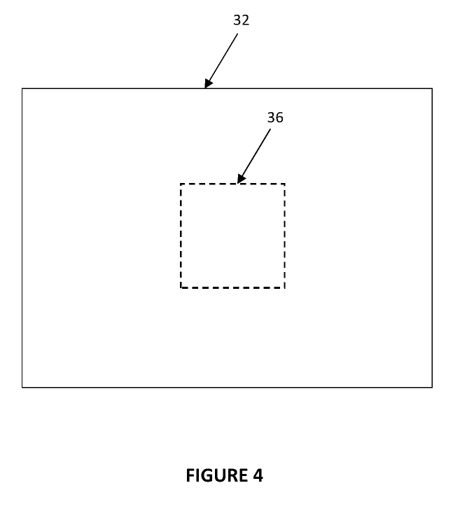

Referring to FIG. 4, the position of the haptic device 36 relative to the touch sensor 32 may vary. The position may change based on the design of the touch sensor system 30 and the type of system in which it is being used. The placement of the haptic device 36 may also depend on whether the haptic device is also providing haptic feedback. In order to prevent interference with operation of the touch sensor 32, the haptic device 36 may be disposed underneath but in contact with the touch sensor.

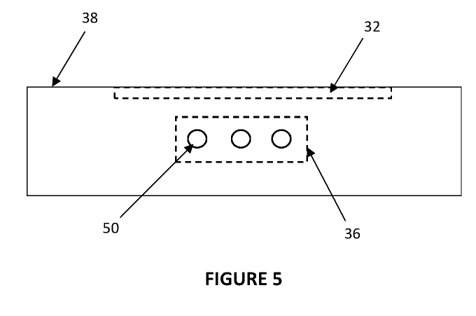

Alternatively, in FIG. 5, a profile view of a housing 38 for the touch sensor 32 shows that the haptic device 36 may be disposed adjacent to but not in direct contact with the touch sensor. For example, the haptic device 36 may be disposed on the inside of the housing 38 of the touch sensor 32. The housing 38 may include a plurality of holes 50 to more easily transmit the audible feedback generated by the haptic device 36. It is noted that the shape and size of the haptic device 36 may vary and should not be considered to be limited by any of the figures. The examples are for illustration purposes only.

It should also be understood that the specific placement of the haptic device 36 relative to the touch sensor 32 may vary and should not be considered as limited to the specific examples given. The haptic device 36 may be disposed in contact with, in partial contact with, or without direct contact with the touch sensor 36.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for providing audible feedback for a touch sensor by using a haptic device, said method comprising:
providing a touch sensor;
providing a touch controller for receiving touch data from the touch sensor;
providing a haptic device for receiving control signals from the touch controller in response to the touch data; and
generating audible feedback by the haptic device in response to contact by at least one pointing object with the touch sensor.

2. The method as defined in claim 1 wherein the method further comprises the step of generating a continuous tone as the audible feedback.

3. The method as defined in claim 1 wherein the method further comprises generating haptic feedback in addition to the audible feedback from the haptic device.

4. The method as defined in claim 1 wherein the method further comprises generating a variety of audible sounds from the haptic device by changing a frequency of the audible feedback, changing a volume of the audible feedback, changing the length of the audible feedback, and changing the number of audible sounds in the audible feedback.

5. The method as defined in claim 1 wherein the method further comprises attaching the haptic device to the touch sensor to thereby enable haptic feedback to a user.

6. A method for providing audible feedback for a touch sensor by using at least two haptic devices, said method comprising:
providing a touch sensor;
providing a touch controller for receiving touch data from the touch sensor;
providing a first haptic device for receiving control signals from the touch controller in response to the touch data;
providing a second haptic device for receiving control signals from the touch controller in response to the touch data; and
generating audible feedback by the first haptic device and generating haptic feedback by the second haptic device in response to contact by at least one pointing object with the touch sensor.

7. The method as defined in claim 6 wherein the method further comprises the step of generating a continuous tone as the audible feedback from the first haptic device.

8. The method as defined in claim 6 wherein the method further comprises generating enabling the first haptic device to generate haptic feedback and the second haptic device to generate audible feedback.

9. The method as defined in claim 6 wherein the method further comprises generating a variety of audible sounds from the haptic device by changing a frequency of the audible feedback, changing a volume of the audible feedback, changing the length of the audible feedback, and changing the number of audible sounds in the audible feedback.

10. The method as defined in claim 6 wherein the method further comprises attaching the first and the second haptic devices to the touch sensor to thereby enable haptic feedback to a user.

11. A system for providing audible feedback for a touch sensor by using a haptic device, said system comprised of:
a touch sensor;
a touch controller coupled to the touch sensor for receiving touch data from the touch sensor; and
a first haptic device coupled to the touch controller for receiving control signals from the touch controller in response to the touch data and including an audible feedback system that generates audible feedback in response to contact by at least one pointing object with the touch sensor.

12. The system as defined in claim 11 wherein the system is further comprised of the first haptic device generating haptic feedback in addition to the audible feedback.

13. The system as defined in claim 11 wherein the first haptic device is further comprised of the audible feedback system that can generate a variety of audible sounds from the first haptic device by changing a frequency of the audible feedback, changing a volume of the audible feedback, changing the length of the audible feedback, and changing the number of distinct audible sounds in the audible feedback.

14. The system as defined in claim 11 wherein the system is further comprised of attaching the first haptic device to the touch sensor to thereby enable haptic feedback to a user of the touch sensor.

15. The system as defined in claim 11 wherein the system is further comprised of a second haptic device, wherein the second haptic device is coupled to the touch controller for receiving control signals from the touch controller in response to the touch data and including a haptic feedback system that generates haptic feedback in response to contact by at least one pointing object with the touch sensor.

16. The system as defined in claim 15 wherein the system is further comprised of the first haptic device including a haptic feedback system that enables the first haptic device to generate haptic feedback, and the second haptic device including an audible feedback system that enables the second haptic device to generate audible feedback.

17. The system as defined in claim 11 wherein the system is further comprised of a housing, wherein the touch sensor, the touch controller and the first haptic device are disposed within the housing with the touch sensor exposed through a hole in the housing.

18. The system as defined in claim 17 wherein the system is further comprised of the first haptic device being coupled to the touch sensor inside the housing.

19. The system as defined in claim 17 wherein the system is further comprised of the first haptic device being coupled to an inside surface of the housing.

20. The system as defined in claim 19 wherein the system is further comprised of a second haptic device, wherein the second haptic device is coupled to the touch controller for receiving control signals from the touch controller in response to the touch data and including a haptic feedback system that generates haptic feedback in response to contact by at least one pointing object with the touch sensor.
